(19) United States
(12) Patent Application Publication
(10) Pub. No.: US 2010/0039412 A1
(43) Pub. Date: Feb. 18, 2010

(54) METHOD AND SYSTEM FOR CONTROLLING OPERATIONS OF A DISPLAY MODULE IN A PORTABLE TERMINAL

(75) Inventors: Hyun Jin KIM, Gwangju (KR); Yong Gook PARK, Yongin-si (KR); Ji Yeon KWAK, Seoul (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/534,273

(22) Filed: Aug. 3, 2009

(30) Foreign Application Priority Data
Aug. 14, 2008 (KR) 10-2008-0079969

(51) Int. Cl. G09G 5/00

(52) U.S. Cl. 345/204

(57) ABSTRACT

The present invention provides a method and system to control operations of a display module in a portable terminal. The system may include a display unit, motors connected to the display unit, a motor driving unit, and a controller. The system may control the display unit so that a portion of the display unit can be protruded or lowered more than other portions of the display unit according to the changes in the screen of the display unit. The method may include checking whether a screen change occurs on a display unit, and controlling, if the screen change occurs, the display unit so that a portion of the display unit can be protruded or lowered relative to other portions of the display unit.

### CROSS REFERENCE TO RELATED APPLICATION

This application claims priority from and the benefit of Korean Patent Application No. 10-2008-0079969, filed on Aug. 14, 2008, which is hereby incorporated by reference for all purposes as if fully set forth herein.

### BACKGROUND OF THE INVENTION

1. Field of the Invention

Exemplary embodiments of the present invention relate to a portable terminal, and more particularly, to a method and system to control changes in a mechanical motion of a display module according to contents displayed on a display unit of a portable terminal.

2. Discussion of the Background

In recent years, portable terminals have been widely used because of their mobility. For example, 85% of people in the Republic of Korea use mobile communication terminals of portable terminals because, for example, the portable terminals allow a user to make a voice call while the user is moving. Conventional mobile communication terminals may provide a variety of functions in addition to the function of communicating voice call information between a caller and a called party. For example, the conventional portable terminal may have a file playback function (e.g., MP3 player), and an image collecting function (e.g., digital camera). The conventional portable terminal can also support, for example, a function for playing a mobile game or an arcade game.

Conventional portable terminals employ devices that can generate input signals by a touch screen method and control the portable terminals according to generated touch events. Therefore, users can more flexibly and rapidly control the conventional portable terminals through the touch screen method. Conventional portable terminals are, however, disadvantageous in that they are limited to processing and displaying data according to the user's input signals, or the portable terminals can only play back stored data. Accordingly, in order to improve user satisfaction, a portable terminal that can be operated more dynamically and can employ an interactive operation needs to be developed.

### SUMMARY OF THE INVENTION

Exemplary embodiments of the present invention provide a method and system to control a mechanical motion of a display module in a portable terminal according to contents displayed on a display unit in the portable terminal.

Additional features of the invention will be set forth in the description which follows, and in part will be apparent from the description, or may be learned by practice of the invention.

Exemplary embodiments of the present invention disclose a method for controlling operations of a display module in a portable terminal. The method comprises determining whether a screen change occurs in a display unit in the display module, and controlling, if the screen change has occurred in the display unit, a portion of the display unit to protrude or be lowered relative to other portions of the display unit.

Exemplary embodiments of the present invention also disclose a system for controlling operations of a display module in a portable terminal. The system comprises a display unit, at least one motor, a motor driving unit, and a controller. The display unit outputs a screen comprising contents. The contents comprise at least one of letters, numbers, and images. At least one motor protrudes or lowers a portion of the display unit. The motor driving unit controls the at least one motor. The controller determines whether a screen change occurs on the display unit, and controls the motor driving unit and the at least one motor if the screen change has occurred so that at least one portion of the display unit is protruded or lowered.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a schematic block diagram illustrating a portable terminal according to exemplary embodiments of the present invention.

FIG. 2 is a detailed perspective view illustrating a display module of the portable terminal shown in FIG. 1 according to exemplary embodiments of the present invention.

FIG. 3 is a view describing momentum and motion direction determined according to the location of contents displayed on the display unit according to exemplary embodiments of the present invention.

FIG. 4 is a view describing momentum and motion direction determined according to the use frequency of contents displayed on the display unit, according to exemplary embodiments of the present invention.

FIG. 5 is a view describing momentum and motion direction determined according to the link relation of contents displayed on the display unit, according to exemplary embodiments of the present invention.

FIG. 6 is a view describing momentum and motion direction determined based on content search according to exemplary embodiments of the present invention.

FIG. 7 is a view momentum and motion direction determined according to whether a scroll bar is displayed, according to exemplary embodiments of the present invention.

FIG. 8 is a flow chart describing a method for controlling operations of a display module in the portable terminal according to exemplary embodiments of the present invention.

### DETAILED DESCRIPTION OF THE ILLUSTRATED EMBODIMENTS

Hereinafter, exemplary embodiments of the present invention are described in detail with reference to the accompanying drawings. The same reference numbers are used throughout the drawings to refer to the same or similar parts. Detailed descriptions of well-known functions and structures incorporated herein may be omitted to avoid obscuring the subject matter of the present invention.

The terms or words described in the present description and the claims should not be limited by a general or lexical meaning. Therefore, one skilled in the art will understand that exemplary embodiments disclosed in the description and configurations illustrated in the drawings are only preferred exemplary embodiments, and that various modifications, alterations, and equivalents thereof to replace the exemplary embodiments at the time of filing this application may be used.

In the following description, various display content are explained based on exemplary embodiments of a portable terminal. Screen changes in the display unit will be explained, according to the distribution of contents displayed on a display unit, the use frequency of contents, a divided form of areas for displaying contents, and a state in which a content includes, for example, a scroll bar. Mechanical motions of a display unit can be controlled according to changes in the various forms of contents, such as letter or number images, displayed on the display unit. Contents displayed on a display unit may include letters, numbers, and images. For example, if numbers are displayed on one side of a portable terminal, when a phone number is input to a portable terminal, the display unit of the portable terminal can be controlled in such a way that the number displaying area of the display unit can be protruded or lowered compared to other areas of the display unit. For example, a portable terminal supporting a full screen may display an image corresponding to a key pad at the bottom area when a phone number is input. In that case, a motor and a motor driving unit can be controlled in such a way that the key pad displaying area of the portable terminal can be protruded or lowered compared to other areas of the display unit. Hereinafter, exemplary embodiments of the present invention will be explained in detail with reference to the accompanying drawings.

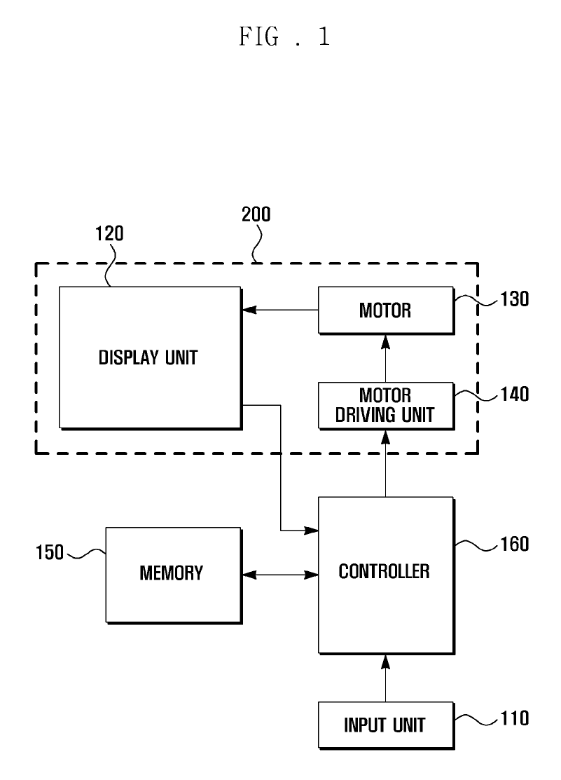

FIG. 1 is a schematic block diagram illustrating a portable terminal according to exemplary embodiments of the present invention.

As shown in FIG. 1, the portable terminal may include a display module 200, a memory 150, an input unit 110, and a controller 160. If the portable terminal is implemented with a mobile communication terminal, the portable terminal may further include a radio frequency (RF) unit (not shown in FIG. 1).

The portable terminal can input signals from a touch screen and/or the input unit 110, and may output a variety of contents stored in the memory 150 to a display unit according to the input signals. The portable terminal may also control mechanical operations of the display module 200 according to a change in contents output on the display unit. Accordingly, the portable terminal may output data through a tactile function, as well as an audio and visual function, based on the operation of the display module 200.

The display module 200 may include a display unit 120, a motor 130, and a motor driving unit 140. The display module 200 can output contents stored in the memory 150 in various forms according to the control of the controller 160, and can also move in a certain direction according to the output form of the contents stored in the memory 150.

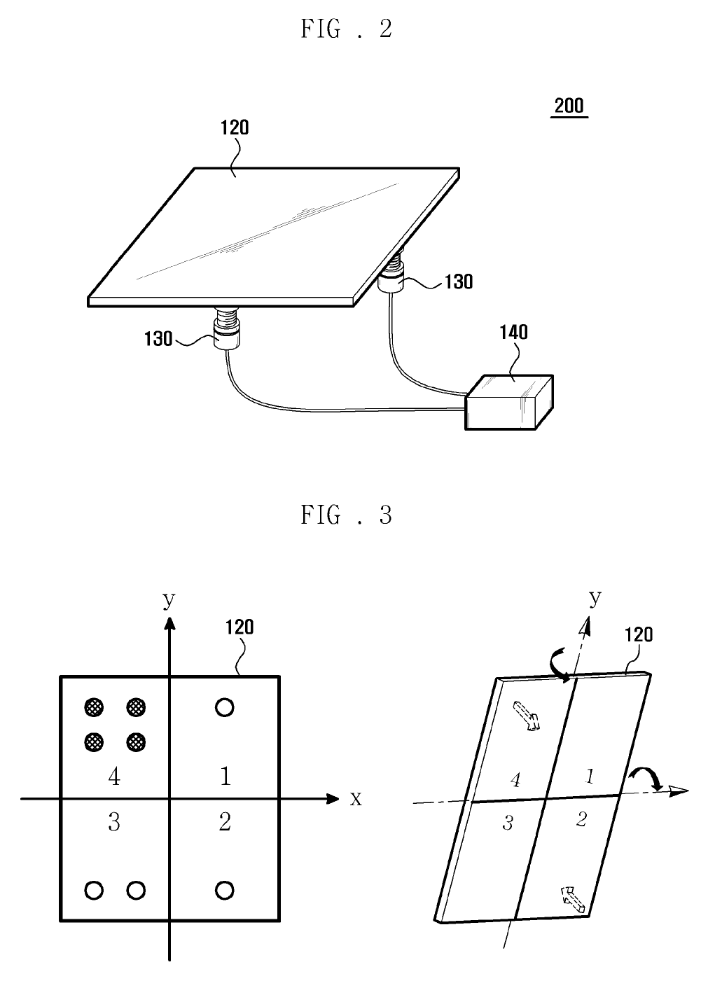

FIG. 2 is a detailed perspective view illustrating a display module of the portable terminal shown in FIG. 1 according to exemplary embodiments of the present invention.

As shown in FIG. 2, the display module 200 may include a display unit 120, at least one motor 130 placed along at least one side of the display unit 120, and a motor driving unit 140 for driving the motor 130. One or more motors 130 may be used and may be situated in any suitable area. The display module 200 may further include a fixing shaft for the center back side of the display unit 120 when a side of the display unit 120 may move up and/or down. The controller 160 may instruct the motor driving unit 140 to operate the motors 130. When the motors 130 perform an up and/or down motion, the display unit 120, placed on the upside of the motors 130, may move up and/or down accordingly. The motors 130 may be connected to first and second side portions of the display unit 120, so that the display unit 120 can move up and/or down. That is, one portion of the display unit 120 may move up and/or down in a first direction and another portion of the display unit 120 may move up and/or down simultaneously in a second direction. Therefore, the display unit 120 can move up and down in all directions when the motors 130, placed at the sides of the display unit 120, are operated. The controller 160 may decide which direction the display module 200 needs to move according to the change of contents output on the display unit 120. The controller 160 may generate a control signal corresponding thereto, and may then output the control signal to the motor driving unit 140.

The display unit 120 may display a variety of menus of a portable terminal, information input by a user, and/or information to be provided to the user. The display unit 120 can provide a variety of screens, such as a standby screen, a menu displaying screen, a content displaying screen, a message writing screen, and/or a call screen. The display unit 120 can also output, according to input signals from the input unit 110, various contents stored in the memory 150. The contents can be partially or wholly displayed on a certain area of the display unit 120. The display unit 120 can be implemented using various displays, including, for example, a liquid crystal display (LCD). If the LCD is implemented to have a touch screen function, the display unit 120 may serve as an input device. The display unit 120 may include a backlight unit for emitting light, a panel for selectively transmitting the emitted light and displaying an image, and a panel driving unit for controlling the panel to selectively transmit light. A method for controlling operation of the display module 200 of the portable terminal and screens displayed on the display unit will be described in further detail below.

The motors 130 may be operated by a signal output from the motor driving unit 140, such as an up and/or down operation signal. When the motors 130 receive the up and/or down operation signal, they may perform right or left rotation, so that one or more sides of the display unit 120 move up and/or down. The motors 130 may be implemented using any suitable motor, for example, servo motors and/or step motors. If the motors 130 are implemented using servo motors, the servo motors can receive information regarding a rotation angle from the motor driving unit 140 and can perform rotation in a certain direction, thereby converting the rotation motion to the vertical motion. Since servo motors can perform accurate vertical motion and rapid rotation motion, the vertical motion of the display unit 120 can be accurately and rapidly controlled.

The motor driving unit 140 may generate and provide signals to drive the motors 130 according to control signals from the controller 160. When the controller 160 decides which part of and how much the display unit 120 may be moved up and/or down according to the change of contents output from the display unit 120, and then outputs control signals to the motor driving unit 140, the motor driving unit 140 may convert the received control signals into a rotation angle value for the motors 130. The motor driving unit 140 may then output the rotation angle value to the motors 130. It should be understood that the motor driving unit 140 can generate various signal values for controlling operations of the motors based on the type of motor being used in the portable terminal.

The memory 150 may store application programs required to perform operations of the portable terminal, and contents transmitted from other portable terminals or servers. The memory 150 may store location information of contents displayed on the display unit 120 and may output the location information to the controller 160. The memory 150 may include a program area and a data area.

The program area may store an operating system (OS) for booting the portable terminal, and application programs for searching contents and supporting a list of contents. The program area may store an operation control program for a display module and may load the control program on the controller 160 according to an input signal. When a user turns on the portable terminal and requests a function, the controller 160 may control a corresponding application so that it can provide the function to the user. The operation control program may control operation of the display unit 120 according to the change of contents output on the display unit 120.

The data area may store data generated as the portable terminal is operated. Examples of the generated data include user data related to various optional functions, such images or moving images photographed by a camera installed in the portable terminal, phone book data, audio data, and information related to contents or user data. The data area can store information regarding icons corresponding to contents or a list of contents, and location values of icons and a list displayed on the display unit 120. The data area can also store information regarding an area of the display unit 120 on which a particular content may be displayed and information regarding an area of the display unit 120 on which the particular content may not be displayed. The controller 160 can generate a scroll bar based on pieces of information stored in the data area.

The controller 160 may control, in part or entirely, the operation of the portable terminal. The controller 160 may generate, according to input signals, control signals required to perform a variety of functions in the portable terminal, and may output the control signals to corresponding elements. The controller 160 may check for changes in the contents output on the display unit 120 based on information regarding the contents stored in the memory 150. The controller 160 may also generate signals for controlling operations of the display module 200 based on the change of contents, and may output the generated signals to the display module 200. For example, the controller 160 can determine the momentum (quantity of motion) and the motion direction of the display module 200 according to locations of contents displayed on the display unit 120, the use frequency of the located contents, link relation of the contents, and a state determining whether a scroll bar is displayed when content is displayed.

The portable terminal may further include a key pad, hotkeys, and/or auxiliary keys that may serve as an input unit 110, as well as a touch screen. These additional input means may generate, according to a user's input, an input signal corresponding to a touch event, and may output the input signal to the controller 160. The input unit 110 may include a plurality of input keys through which a user inputs number and/or text information. The input unit 110 may also include function keys for setting a variety of functions. The function keys may include direction keys, side keys, and/or shortcuts, which may be set to perform specific functions. The input unit 110 may generate key signals related to a user's setting and function control of the portable terminal, and may output the key signals to the controller 160.

If the portable terminal is implemented with a mobile communication terminal, the portable terminal may include an RF communication unit. The RF communication unit may establish communication channels for making a voice call and for transmitting data, such as images, according to control of the controller 160.

As described above, the portable terminal may determine the momentum and the motion direction of the display module 200 according to the change of contents displayed on the display unit 120 and may move the display module 200 to provide dynamic and sensitive information to the user, and can respond to various needs of the user.

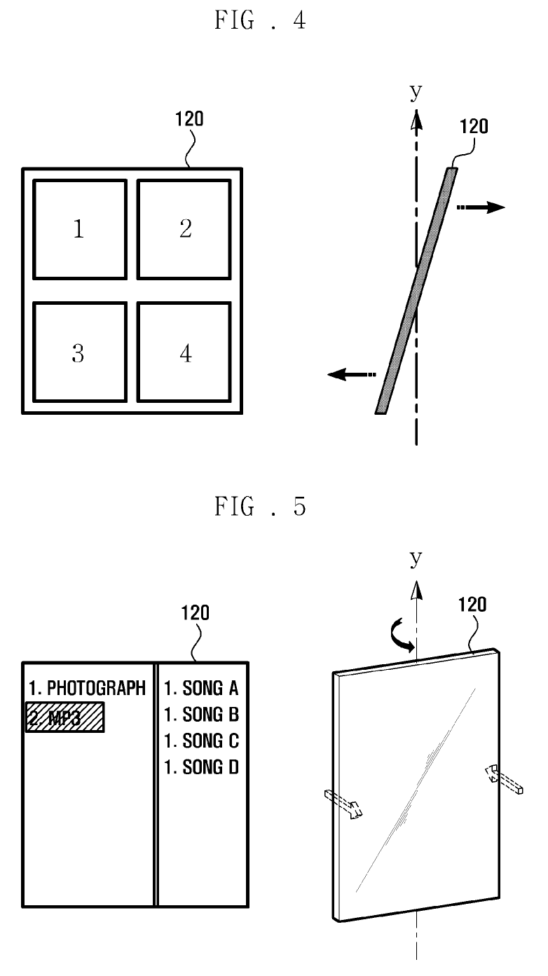

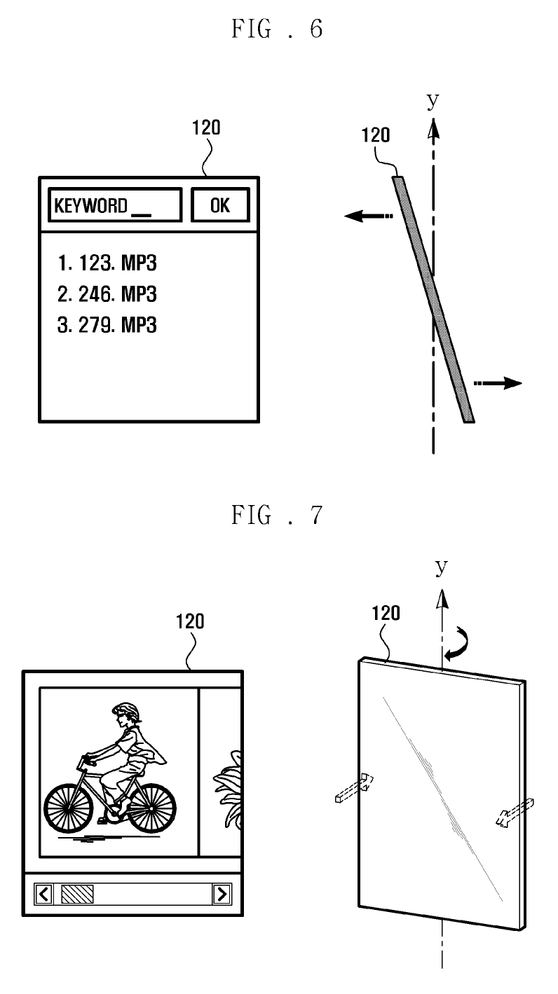

FIG. 3, FIG. 4, FIG. 5, FIG. 6, and FIG. 7 show views for describing how the display module 200 may determine momentum and motion direction according to changes in the contents displayed on the display unit 120.

FIG. 3 is a view describing momentum and motion direction determined according to the location of contents displayed on the display unit 120. It is assumed that the portable terminal user can select and search for contents stored in the memory using the input unit or a touch screen.

Referring to FIG. 3, the controller 160 may collect coordinate information regarding contents displayed on the display unit 120. The controller 160 may divide the display unit 120 into a number (e.g., one or more) of portions with respect to the center of the display unit 120. For example, the controller 160 may divide the display unit 120 into four portions, namely a first portion in the top right of the display unit 120, a second portion in the bottom right of the display unit 120, a third portion in the bottom left of the display unit 120, and a fourth portion in the top left of the display unit 120. An icon corresponding to a single content may be situated in each of the first and second portions of the display unit 120, respectively. Icons corresponding to two contents may be situated in the third portion. Icons corresponding to four contents may be situated in the fourth portion. The controller 160 may detect that the fourth portion has the largest number of content icons, and may control the motor driving unit so that the fourth portion can be protruded or lowered more than other portions of the display unit 120, with respect to the front surface of the display unit 120, as shown in FIG. 3. A first motor may be installed at the lower surface of the display unit 120 at a middle point of the side between the first and second portions. A second motor may be installed at the lower surface of the display unit 120 at a middle point of the side between the second and third portions. The fourth portion can be protruded or lowered, compared to other portions, as the first and second motors are moved up and down.

FIG. 4 is a view describing momentum and motion direction determined according to the frequency (use frequency) of using and/or accessing contents displayed on the display unit 120. The icons displayed on the display unit 120 may correspond to menu icons, and the number labels of the menu icons may indicate the rank of the use frequency of the menu icons. For example, the menu icon used or accessed most frequently in a predetermined period of time may be numbered 1. Similarly, the menu icon used and/or accessed the least frequently may be numbered 4. The use frequency of each menu icon can be calculated as the controller 160 tracks the number of times a menu icon is used and/or accessed in a certain period of time.

As shown in FIG. 4, the controller 160 can perform a control operation so that the portion where the menu icon numbered 1 is located can be protruded or lowered more than other portions where other menu icons are located. For example, a first motor may be installed at the lower surface of the display unit 120 at the middle point of the right side (e.g., between menu icons 2 and 4) of the display unit 120. A second motor may be installed at the lower surface of the display unit 120 at the middle point of the bottom side (e.g., between menu icons 3 and 4) of the display unit 120. The controller 160 may output control signals to the motor driving unit 140 so that the first and second motors can move up and/or down. That is, the motor driving unit 140 may rotate the first and second motors according to the control signals so that the motors can move the display unit 120 up and/or down. Accordingly, a portion of the display unit 120 having a menu icon labeled 4 may move up and/or down, and a portion of the display unit 120 having a menu icon numbered 1 may be relatively protruded or lowered.

The display unit 120 may form an elastic fixing member on the center, lower surface thereof. The elastic fixing member may movably support the display unit 120, so that the display unit 120 can perform a protruding or lowering motion.

FIG. 5 is a view describing momentum and motion direction determined according to a link relation of contents displayed on the display unit 120 according to exemplary embodiments of the present invention. When the portable terminal is booted and displays a standby screen, the portable terminal may receive an input signal for enabling a particular menu, such as an MP3 player function to search a music file. The controller 160 may then output a list of files of the various content stored in the memory, so that the files can be reproduced when the MP3 player function is enabled.

As shown in FIG. 5, the display unit 120 may display items in a left portion of the display unit 120, and sub-items in a right portion of the display unit 120. The sub-items may be linked to an item on the left portion. The controller 160 may determine a link relation between items and sub-items displayed on the display unit 120. If an item is displayed on the left portion of the display unit 120 and sub-items of the item are displayed on the right portion, the controller 160 may perform a control operation so that the right or left portion of the display unit 120 can be protruded or lowered more than the left or right portion of the display unit 120. That is, the display unit 120 can be operated in such a way that its right portion is more protruded than its left portion or vice versa, according to the link relation of the items corresponding to contents displayed on the display unit 120.

FIG. 6 is a view describing momentum and motion direction determined based on content search according to exemplary embodiments of the present invention.

Referring to FIG. 6, the display unit 120 may display an input field for receiving a keyword, and a confirmation key for executing a searching operation after the keyword has been input in the input field. The input field may be situated in a top portion of the display unit 120, or in general, in any suitable location of the display unit 120. The confirmation key can be implemented with a button. If the display unit 120 is implemented by a touch screen, the confirmation key can be located near the keyword input field to rapidly perform a searching operation after a keyword has been input. The confirmation key may not be additionally provided, and, if an input unit is provided, the confirmation key can be replaced with a confirmation key included in the input unit. If a keyword is input, the controller 160 may search for content corresponding to the input keyword from the memory, and may output a list of related searched contents on the display unit 120. The searched contents may be displayed in any suitable portion of the display unit 120, for example, below the keyword input field. Therefore, the display unit 120 may display the keyword input field in the upper portion of the display unit 120 and the list of contents corresponding to the input keyword in the lower portion of the display unit 120. It should be understood that any suitable geometric configuration may be used to display the keyword input field and the searched contents.

For certain processes, the controller 160 can perform a control operation so that the upper portion of the display unit 120 can be protruded or lowered. For example, when a keyword needs to be input into the keyword input field or when a user requests a menu activation for searching content, and if the display unit has been divided into portions, the controller 160 can protrude or lower a portion where a cursor is located. After a keyword is input into the keyword input field, if a searching operation has been completed and a list of contents is displayed below the keyword input field, the controller 160 can perform a control operation so that the lower portion of the display unit 120, displaying the list of contents, can be protruded or lowered more than portions of the display unit 120 displaying the keyword input field. That is, if the display unit 120 is divided into an upper portion and a lower portion and a keyword input field and a list of searched contents are displayed on the upper portion and on the lower portion, respectively, the controller 160 can protrude or lower the upper portion of the display unit 120 before a keyword is input and the lower portion if the list of contents has been searched.

As can be appreciated from the foregoing description, the display unit 120 can determine momentum and motion direction according to the change of contents displayed on the display unit 120. Therefore, information can be more tactilely and interactively provided to the user.

FIG. 7 is a view describing momentum and motion direction determined based on whether a scroll bar is displayed according to exemplary embodiments of the present invention. A portable terminal user may search contents that can be displayed using a scroll bar, such as photographs, albums, web pages, and/or lists.

Referring to FIG. 7, when a portable terminal user selects a particular content, or, for example, searches for a photograph, the display unit 120 may display the photograph. If additional photographs need to be displayed, the additional photographs may be provided at the side of the display unit 120. For example, the display unit 120 can display a portion of the other photographs at the edge of the side of the display unit 120. Also, to indicate the additional photographs, the display unit 120 can display a scroll bar at the bottom end thereof. That is, when the controller 160 receives an input signal to search for a particular photograph or photographs, the controller 160 may check whether photographs corresponding to the input signals are stored and may then instruct the display unit 120 to display the searched photographs. The controller 160 may readjust the size of a plurality of photographs according to a preset condition, and may then output the photographs on the display unit 120. The controller 160 may also display a particular photograph, and may not directly output other photographs on the display unit 120. Although the controller 160 does not output the other photographs, the display unit 120 can display a scroll bar to indicate that other searched photographs remain. Additionally, if a particular photograph is larger than the display unit 120, the controller 160 may display a scroll bar to enable viewing of the full photograph.

Although this exemplary embodiment of the present invention is explained using a process of searching and displaying a photograph, it should be understood that the exemplary embodiment can be modified and may be, for example, a process of searching a webpage or a list. For example, if selecting a particular content may be implemented by webpage search, the display unit 120 may display a portion of the entire webpage, and may also display a scroll bar corresponding to a portion on which the remaining web page(s) is not displayed. If selecting a particular content is implemented with a list display, the display unit 120 may display a part of the list and a scroll bar to indicate that remaining parts of the list are not displayed.

When a scroll bar is displayed, for example, at one side of the display unit 120, a portion of the display unit 120, which the scroll bar is intended to move, may be protruded or lowered more than other portions. That is, when a scroll bar is displayed on the display unit 120, the controller 160 may check information regarding motion direction of the scroll bar, and may then control a motor driving unit and a motor to protrude or lower the corresponding portion of the display unit 120 according to the movement of the scroll bar.

FIG. 7 illustrates an example in which a searched photograph result is provided and additional photographs may be available to view on the right side of the display unit 120. When a user views photographs using a scroll bar, the controller 160 can determine the motion direction of the scroll bar. For example, the scroll bar can be moved from the right to the left to display photographs that have not have been displayed. The controller 160 can then perform a control operation such that the right portion of the display unit 120 may be protruded or lowered more than the left portion of the display unit 120.

If the scroll button in the scroll bar moves while searching the plurality of photographs and can be moved to the left and right, the controller 160 may compare the number of photographs located at the left portion with the number of photographs located at the right portion, with respect to a photograph currently displayed on the display unit 120, and may then protrude or lower the portion of the display unit 120 in which a greater number of photographs are located relative to other portions of the display unit 120.

For example, if, with respect to the photograph currently displayed on the display unit 120, the number of searched photographs, located at the left portion of the display unit 120, is the same as the number of non-searched photographs located at the right portion of the display unit 120, the controller 160 can instruct the display unit 120 to keep its surface even (e.g., horizontal). That is, the controller 160 can detect the point where the scroll button is located on the scroll bar and can control the display unit 120 to be protruded or lowered according to the location of the scroll button. For example, if the scroll button is located at the middle point of the scroll bar, the controller 160 may instruct the display unit 120 to keep its surface flat (e.g., horizontal). If the scroll button is located at the left or right with respect to the middle point of the scroll bar, the controller 160 may instruct the display unit 120 so that the portion of the display unit 120 that the scroll button is located towards, is protruded or lowered more than the opposite portion. It should be understood that various alterations and modifications of such exemplary embodiments are possible. For example, the controller 160 can control the display unit 120 so that the portion of the display unit 120 where the scroll bar is located can be protruded or lowered more than other portions of the display unit 120.

As described above, a system for controlling the motion of the display unit according to contents displayed on the display unit according to a user's input may be provided herein.

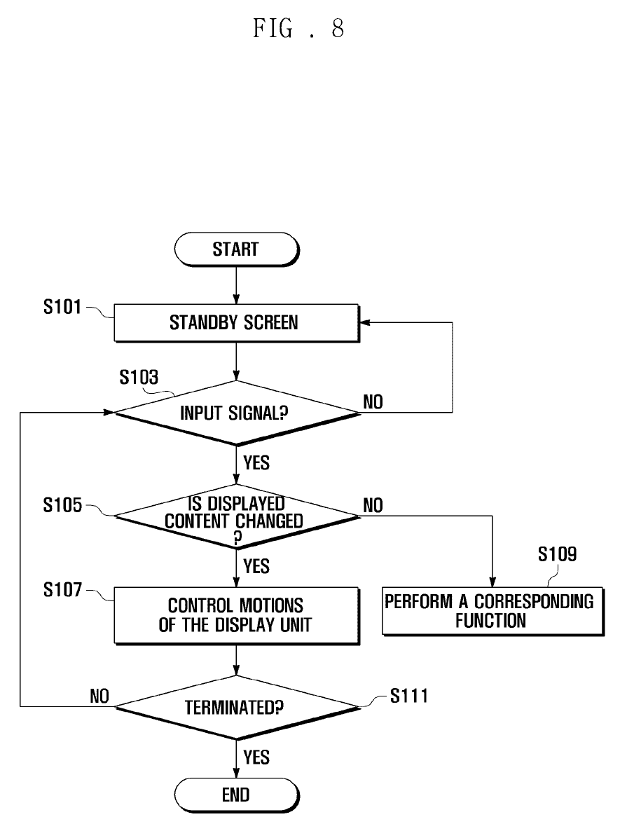

In the following description, a method for controlling operations of a display module in a portable terminal is described in detail with reference to FIG. 8.

FIG. 8 is a flow chart describing a method for controlling operations of a display module in the portable terminal according to exemplary embodiments of the present invention.

Referring to FIG. 8, when power is supplied to the portable terminal according to a user's input signal, the portable terminal may be booted and may display a standby screen on the display unit 120 (S101).

The controller 160 may determine whether a signal is input through the input unit 110 or the touch screen of the display unit 120 (S103). The touch screen may be provided, in some cases, at one side of the display unit 120, and may generate an input signal that may be, in some cases, the same input signal as the signal generated by the input unit 110, and may then output the input signal to the controller 160. If the display unit 120 is implemented with a touch screen, the input unit 110 may, in some cases, not be included in the portable terminal.

If the controller 160 ascertains that a signal is not input at S103, the controller 160 may return to step S101 where a standby screen may be displayed. If the controller ascertains that a signal is input at S103, the controller may determine whether content displayed on the display unit 120 has changed according to the input signal (S105). Examples of input signals causing change in the displayed contents include, but are not limited to, an input signal corresponding to numbers, letters, menus enabled by menu keys, enabling a keyword field for list search, outputting a list that corresponds to a keyword input to the keyword input field, and/or outputting web pages that contain a scroll bar on a display unit when the portable terminal accesses a web server. When an input signal is input, the controller 160 may perform a function corresponding to the input signal, and may check a list of contents to be displayed on the display unit 120, the use frequency of contents, a determination as to whether to use a scroll bar during a content search, and/or distribution of contents. The controller 160 may also determine whether each function meets a particular condition (i.e., a preset condition) that is previously set so that a particular portion of the display unit is protruded or lowered more than other portions.

If the controller 160 ascertains that the input signal meets a condition so that a particular portion of the display unit 120 can be changed at S105, the controller 160 may control motions of the display unit (S107). That is, considering, for example, the distribution of contents on the display unit, the use frequency of contents, whether a scroll bar is contained in a content, and whether a display unit is divided into portions for displaying contents, the controller 160 may perform a control operation so that a particular portion of the display unit 120 can be protruded or lowered according to a preset condition.

The controller 160 may then determine whether to continue to control a mechanical motion of the display unit according to changes in the display of at least one content (S111). If the controller 160 determines to continue to control a mechanical motion of the display unit at S111, the controller 160 may return to and proceed with Step S103. If the controller 160 determines not to continue to control a mechanical motion of the display unit at S111, the controller 160 may terminate the process.

If the controller 160 ascertains that the input signal, such as a camera operation signal, and/or a broadcasting screen outputting signal, does not relate to the changes of contents displayed on the display unit at 105, the controller 160 may perform a corresponding function (S109).

Accordingly, as described hereinabove, a method for controlling operations of a display module in a portable terminal can provide control of a mechanical motion of a display unit according to the properties of contents displayed on the display unit. The method and system may also control operations of a display module in a portable terminal according to the change of contents displayed on the display unit of the portable terminal.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method for controlling operations of a display module in a portable terminal, comprising:
determining whether a screen change occurs on a display unit in the display module; and
controlling, if the screen change has occurred on the display unit, a portion of the display unit to protrude or lower relative to other portions of the display unit.

2. The method of claim 1, wherein:
determining whether a screen change occurs on a display unit comprises determining whether at least one of a letter, number, and image is displayed on the display unit, and
wherein controlling the display unit comprises performing a control operation to protrude or lower, relative to other portions of the display unit, a portion of the display unit displaying the at least one of the letter, number, and image.

3. The method of claim 1, wherein determining whether a screen change occurs on a display unit comprises:
dividing the display unit into a plurality of portions; and
determining distribution of contents displayed on the plurality of portions, and
wherein controlling the display unit comprises performing a control operation to protrude or lower, relative to other portions of the display unit, a portion of the display unit comprising a relatively larger number of the contents.

4. The method of claim 1, wherein determining whether a screen change occurs on a display unit comprises determining a use frequency of contents displayed on the display unit, and
wherein controlling the display unit comprises performing a control operation to protrude or lower, relative to other portions of the display unit, a portion of the display unit comprising content with relatively higher use frequency.

5. The method of claim 1, wherein determining whether a screen change occurs on a display unit comprises:
determining divided portions of the display unit; and
identifying a divided portion on which a cursor is located, and
wherein controlling the display unit comprises performing a control operation to protrude or lower, relative to other portions of the display unit, the divided portion of the display unit on which the cursor is located.

6. The method of claim 5, wherein determining whether a screen change occurs on a display unit further comprises determining whether a keyword is input in the divided portion of the display unit on which the cursor is located, and
wherein controlling the display unit comprises performing a control operation to protrude or lower, relative to other portions of the display unit, a portion of the display unit comprising a displayed list of contents corresponding to the keyword.

7. The method of claim 1, wherein determining whether a screen change occurs on a display unit comprises determining whether a scroll bar is displayed on the display unit, and
wherein controlling the display unit comprises performing a control operation to protrude or lower, relative to other portions of the display unit, a portion of the display unit comprising the displayed scroll bar.

8. The method of claim 1, wherein determining whether a screen change occurs on a display unit comprises:
determining whether a scroll bar is displayed on the display unit; and
identifying a location of a scroll button on the scroll bar, and
wherein controlling the display unit comprises performing a control operation to protrude or lower, relative to other portions of the display unit, a portion of the display unit comprising the scroll button, based on the identified location.

9. The method of claim 8, wherein controlling the display unit comprises:
controlling the display unit to keep a horizontal state if the scroll button is located at a middle point of the scroll bar; and
controlling, if the scroll button is not located at the middle point of the scroll bar, the display unit to protrude or lower, relative to other portions of the display unit, a portion of the display unit comprising the scroll button.

10. A system for controlling operations of a display module in a portable terminal, comprising:
a display unit to output a screen comprising contents, the contents comprising at least one of letters, numbers, and images;
at least one motor to protrude or lower a portion of the display unit;
a motor driving unit to control the at least one motor; and
a controller to determine whether a screen change occurs on the display unit, and to control the motor driving unit and the at least one motor if the screen change has occurred so that at least one portion of the display unit is protruded or lowered.

11. The system of claim 10, further comprising:
a touch screen or an input unit to generate an input signal for changing the screen of the display unit; and
a memory to store the contents.

12. The system of claim 10, wherein, if the at least one of letters, numbers, and images is displayed on the display unit, the controller performs a control operation to protrude or lower, relative to other portions of the display unit, a portion of the display unit displaying the at least one of letters, numbers, and images.

13. The system of claim 10, wherein the controller divides the display unit into a plurality of portions, determines distribution of contents displayed on the divided portions, and performs a control operation to protrude or lower, relative to other portions of the display unit, a portion of the display unit having a relatively larger number of the contents.

14. The system of claim 10, wherein the controller determines a use frequency of contents displayed on the display unit, and performs a control operation to protrude or lower, relative to other portions of the display unit, a portion of the display unit having content with relatively higher use frequency.

15. The system of claim 10, wherein the controller determines divided portions of the display unit, determines a divided portion on which a cursor is located, and performs a control operation to protrude or lower, relative to other portions of the display unit, the divided portion of the display unit on which the cursor is located.

16. The system of claim 15, wherein the controller determines whether a keyword is input in the divided portion on which the cursor is located, and performs a control operation to protrude or lower, relative to other portions of the display unit, a portion of the display unit comprising a displayed list of contents corresponding to the keyword.

17. The system of claim 10, wherein the controller determines whether a scroll bar is displayed on the display unit, and performs a control operation to protrude or lower, relative to other portions of the display unit, a portion of the display unit comprising the displayed scroll bar.

18. The system of claim 10, wherein the controller determines whether a scroll bar is displayed on the display unit, identifies a location of a scroll button on the scroll bar, and performs a control operation to protrude or lower, relative to other portions of the display unit, a portion of the display unit comprising the scroll button, based on the identified location.

19. The system of claim 18, wherein the controller controls the display unit to keep a horizontal state if the scroll button is located at a middle point of the scroll bar, and, if the scroll button is not located at the middle point of the scroll bar, controls the display unit to protrude or lower, relative to other portions of the display unit, a portion of the display unit having the scroll button.
